(19) United States
(12) Patent Application Publication
(10) Pub. No.: US 2006/0095825 A1
(43) Pub. Date: May 4, 2006

(54) Firmware management apparatus and method

(75) Inventor: Tien-Hui Pan, Jhongli City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/176,462

(22) Filed: Jul. 7, 2005

(30) Foreign Application Priority Data
Jul. 16, 2004 (TW) 93121272

(51) Int. Cl. H04L 1/00

(52) U.S. Cl. 714/746

(57) ABSTRACT

An apparatus for firmware management. A non-volatile memory device stores encoded data comprising an instruction and an error correction code. A processing unit acquires the encoded data, and corrects the encoded data based on the error correction code when an error in the encoded data is detected. The processing unit subsequently acquires the instruction from the corrected data, and then executes the instruction.

### BACKGROUND

The invention relates to firmware access technology, and more particularly, to an apparatus and method for firmware management.

Computer systems include various types of memory devices. Some memory devices are referred to as “volatile” meaning that data stored therein is lost when powered off. Other memory devices are “non-volatile” meaning that data is retained when powered off.

Volatile memory, such as dynamic random access memory (DRAM), or more specifically synchronous DRAM (SDRAM), is typically employed as the main memory of a computer. When booted, the computer operating system is loaded to the main system memory and executed by the processor. As applications are opened they are copied from the storage drive (e.g., hard drive, CD-ROM drive) into the main system memory for execution. The main system memory is also used to temporarily store data, configuration, and other types of information that the computer may require during operation.

Non-volatile memory is useful for storing software code that the computer may execute each time it is booted, typically referred to as firmware. Most computers have a set of executable routines called the basic input/output system (BIOS). These routines provide access to various input and output devices such as floppy disk drives, displays, and the like. The BIOS is permanently stored in a non-volatile memory device called a read only memory (ROM).

It may be desirable to update the firmware stored in the ROM to enhance performance for example, and some types of ROM devices permit firmware updates, and electrically erasable programmable read only memory (EEPROM) ROM is an example. To reprogram an EEPROM (a process referred to as flashing the ROM), the data stored therein is first erased and new data is then stored in the device.

In addition to computer systems, I/O devices, communication devices, embedded devices and other electronic devices may also have both volatile and non-volatile memories. FIG. 1 shows the hardware architecture of a conventional reading apparatus. The reading apparatus 10 comprises a mechanical device 11, a control unit 12 and a reading component 13. The reading component 13 comprises a pickup head (not shown), reading data from an optical storage medium. The mechanical device 11 comprises a rotary motor (not shown), operating during a data reading process. The control unit 12 comprises a chip/chipset 121, a memory device 123 and a volatile memory device (not shown). The memory device 123 is preferably non-volatile, such as a ROM, an EEPROM, a flash ROM, or other memory device retaining data after power-down. The reading component 13, mechanical device 11 and the control unit 12 are essential parts of a conventional reading apparatus.

Typically, an inadequate power on, power reset or unstable power supply may damage firmware in a non-volatile memory, resulting in failure of computer systems, I/O devices, communication devices, embedded devices or electronic devices. In order to recover the damaged firmware, new firmware may be searched for and downloaded via Internet. The labor-intensive nature of firmware location, downloading and replacement using conventional means is detrimental to client satisfaction. In view of these limitations, a need exists for an apparatus and method of firmware management with automated firmware detection and correction.

### SUMMARY

The invention discloses an apparatus for firmware management. The apparatus comprises a non-volatile memory device and a processing unit. The non-volatile memory device stores encoded data comprising an instruction and an error correction code. The processing unit acquires the encoded data, and corrects the encoded data based on the error correction code when an error is detected. The processing unit subsequently acquires the instruction from the corrected data, and executes the instruction. Note that the corrected data also comprises an instruction and an error correction code. The processing unit may further store the corrected data to the non-volatile memory device. The processing unit may also acquire the instruction from the encoded data after detecting the encoded data is correct, and then execute the instruction. Preferably, the encoded data is corrected by an error correction method, and the instruction is acquired from the corrected data by a decoding method. The apparatus may further comprise a chip/chipset comprising the decoding method and the error correction method.

Also disclosed is a method for firmware management, executed by a processing unit of an apparatus comprising a non-volatile memory device. The method comprises acquiring encoded data comprising an instruction and an error correction code from the non-volatile memory device and correcting the encoded data based on the error correction code when an error is detected, acquiring the instruction from the corrected data, and executing the instruction. The method may additionally comprise acquiring the instruction from the encoded data after detecting that the encoded data is correct, and then execute the instruction. The method may also comprise storing the corrected data to the non-volatile memory device. Preferably, the encoded data is corrected by an error correction method, and the instruction is acquired from the corrected data by a decoding method. The apparatus may further comprise a chip/chipset comprising the decoding method and the error correction method.

Further disclosed is another method for firmware management, executed by a processing unit of an apparatus comprising a non-volatile memory device. The method comprises acquiring an instruction corresponding to firmware of the apparatus, inserting an error correction code which is been employed to validate the instruction into the instruction to generate encoded data by an encoding method, and storing the encoded data to the non-volatile memory device. The instruction may be downloaded from a website.

Preferably, the instruction comprises firmware of the apparatus, and the encoded data and the corrected data correspond to Cross-Interleaved Reed-Solomon Code (CIRC), cyclic redundancy check code (CRCC), converlotion code, hamming code, Trelix code, Data Encryption Standard (DES) code.

### BRIEF DESCRIPTION OF THE DRAWINGS

The invention can be more fully understood by reading the subsequent detailed description and examples of embodiments thereof with reference made to the accompanying drawings, wherein:

FIG. 1 is a diagram of the hardware architecture of a conventional reading apparatus;

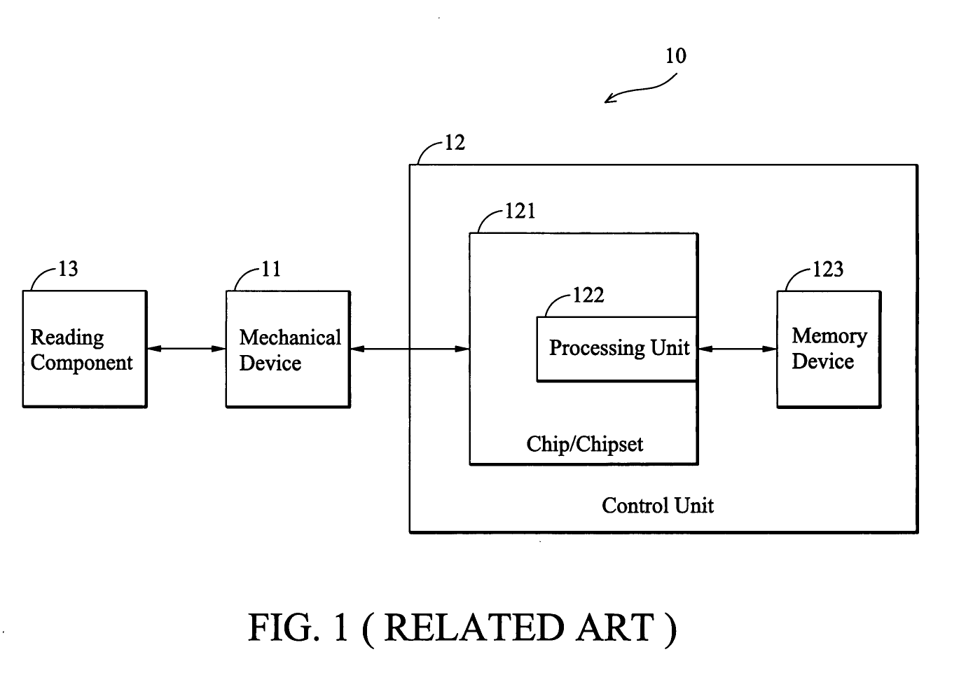

FIG. 2 is a diagram of the hardware architecture of an electronic apparatus for firmware management according to an embodiment of the invention;

FIG. 3 is a flowchart of a firmware execution method according to an embodiment of the invention;

FIG. 4 is a flowchart of a firmware writing method according to an embodiment of the invention.

### DETAILED DESCRIPTION

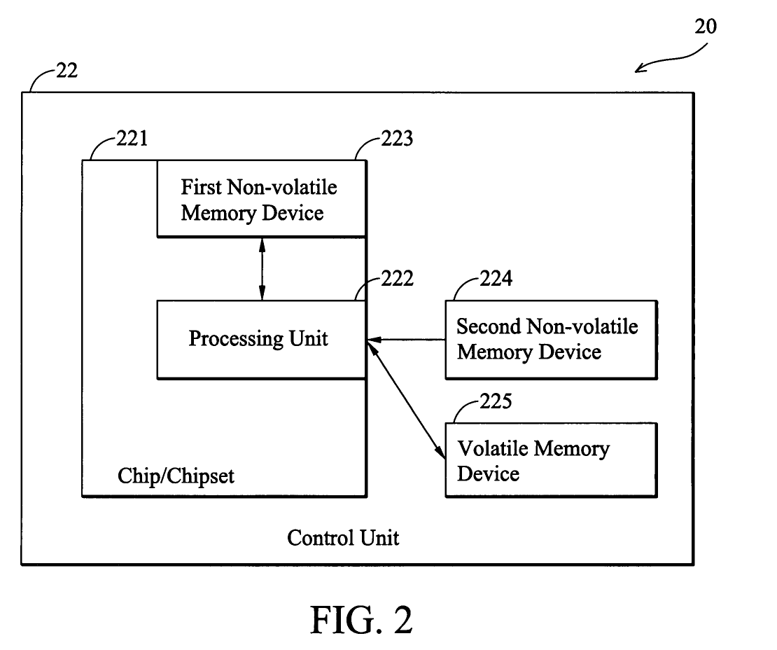

FIG. 2 shows the hardware architecture of an electronic apparatus for firmware management according to an embodiment of the invention. The electronic apparatus 20 comprises a control unit 22. The electronic apparatus 20 may be a computer system, I/O device, communication device, embedded device or others. The I/O device may be an optical reading device, optical reading/writing device, hard drive, portable drive, display device, scanner, printer and the like. The communication device may be a mobile phone, access point, bridge, hub, router, switch, gateway and the like. The embedded device may be a personal digital assistant (PDA), CD player, DVD player, game controller, home server and the like. The control unit 22 comprises a chip/chipset 221, a second non-volatile memory device 224 and a volatile memory device 225. The volatile memory device 225 may be a dynamic random access memory (DRAM) device, synchronous DRAM (SDRAM) or other memory device that loses data after power-down. The chip/chipset 221 comprises a processing unit 222 and a first non-volatile memory device 223. The non-volatile memory devices 223 and 224 are preferably electrically erasable programmable read only memory (EEPROM) devices, flash read only memory (ROM) devices or other memory devices retaining data after power-down. Those skilled in the art will recognize that the processing unit 222, first non-volatile memory device 223, second non-volatile memory device 224 and/or volatile memory device 225 may be configured in the chip/chipset 221 or outside of the chip/chipset 221.

The second non-volatile memory device 224 stores encoded data comprising firmware instructions and error correction codes therewith. The encoded data may correspond to Cross-Interleaved Reed-Solomon Code (CIRC), cyclic redundancy check code (CRCC), converlotion code, hamming code, Trelix code, Data Encryption Standard (DES) code or others. The error correction codes may be generated according to firmware instructions and inserted in the firmware instructions. The inserted error correction codes may be utilized to validate firmware instructions by an error detection method and/or to correct bad firmware instructions by an error correction method. With improved correction efficiency, the error detection method or error correction method preferably is implemented as an integrated circuit in the chip/chipset 221. The error detection method and/or error correction method may also be implemented as software instructions in the first non-volatile memory device 223, second non-volatile memory device 224 or volatile memory device 225. In addition to the error detection method, error correction method, the chip/chipset 221, first non-volatile memory device 223, second non-volatile memory device 224 or volatile memory device 225 may comprise a decoding method for acquiring firmware instructions from encoded data. The error detection method determines which bit/bits occur error(s), and the error correction method correct such bit/bits based on corresponding error correction codes.

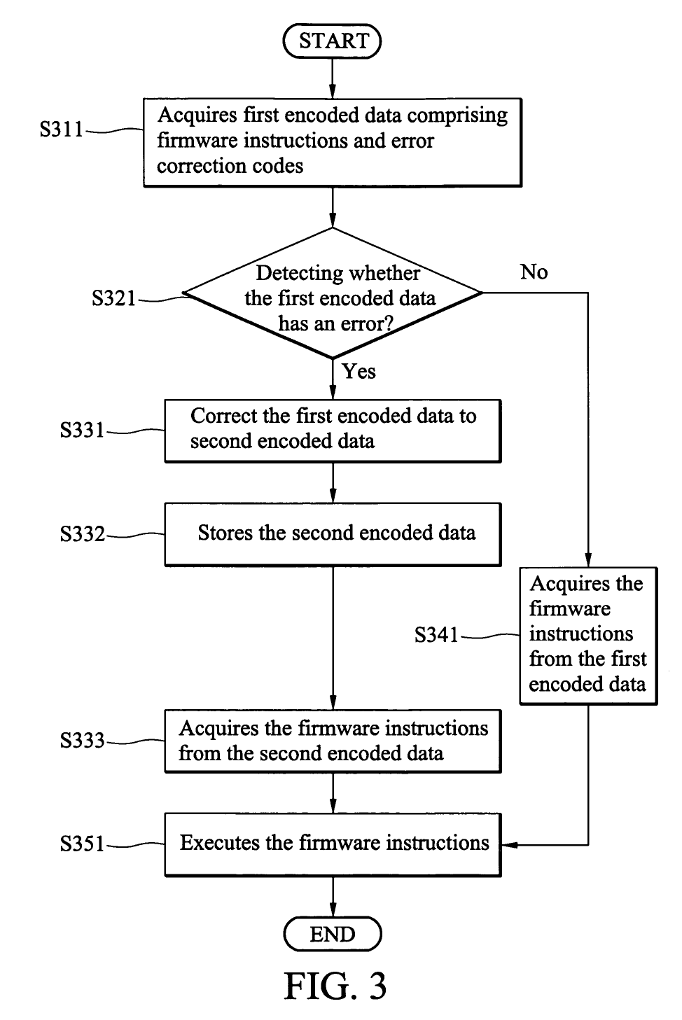

The first non-volatile memory device 223, preferably a mask ROM, comprises a firmware execution module loaded and executed by the processing unit 222 to perform a firmware execution method when the electronic apparatus 20 starts. FIG. 3 is a flowchart of a firmware execution method according to an embodiment of the invention.

In step S311, first encoded data comprising firmware instructions and error correction codes therewith is acquired from the second non-volatile memory device 224. The first encoded data may correspond to Cross-Interleaved Reed-Solomon Code (CIRC), cyclic redundancy check code (CRCC), converlotion code, hamming code, Trelix code, Data Encryption Standard (DES) code or others. In step S321, it is determined that the first encoded data has error bit/bits by an error detection method, if so, the process proceeds to step S331, and otherwise, to step S341. In step S341, firmware instructions are acquired from the first encoded data by a decoding method. In step S331, the first encoded data is corrected to generate second encoded data with no errors by an error correction method. In step S332, the second encoded data is stored in the second non-volatile memory device 224. Note that this step may be omitted if the second non-volatile memory device is a ROM. In step S333, firmware instructions are acquired from the second encoded data by the decoding method. In step S351, the acquired firmware instructions are executed.

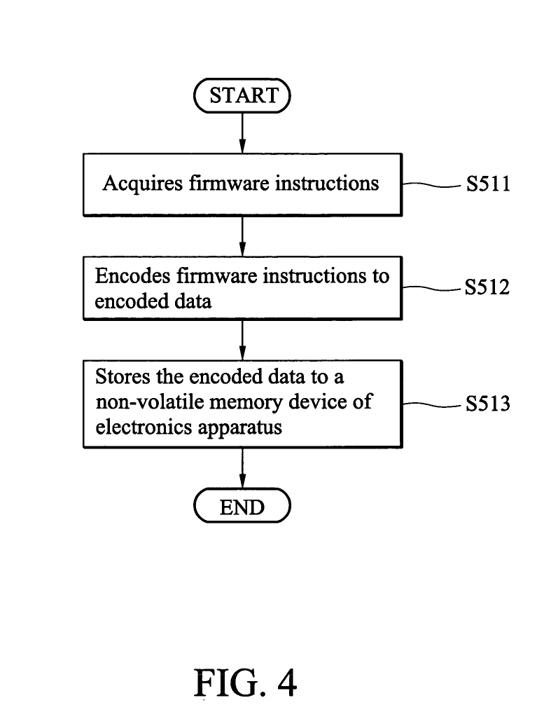

An embodiment of the invention further discloses a firmware writing method executed by the processing unit 222. FIG. 4 is a flowchart of a firmware writing method according to an embodiment of the invention.

In step S511, firmware instructions corresponding to the electronic apparatus 20 are acquired via various networks, such as local area networks (LANs), wireless local area networks (WLANs), Internet, or wireless telephony networks, or from a storage device. In step S512, the acquired firmware instructions are encoded to encoded data comprising error correction codes. The encoded data may correspond to Cross-Interleaved Reed-Solomon Code (CIRC), cyclic redundancy check code (CRCC), converlotion code, hamming code, Trelix code, Data Encryption Standard (DES) code or others. In step S513, the encoded data is stored in the second non-volatile memory device 224.

Methods and systems of embodiments of the invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the invention has been described in terms of preferred embodiment, it is not intended to limit the invention to the precise embodiments disclosed herein. Those who are skilled in this technology can still make various alterations and modifications without departing from the scope and spirit of this invention. Therefore, the scope of the invention shall be defined and protected by the following claims and their equivalents.

What is claimed is:

1. An apparatus for firmware management, comprising:
a non-volatile memory device configured to store encoded data, the encoded data comprising an instruction and an error correction code; and
a processing unit coupled to the non-volatile memory device, acquiring the encoded data, correcting the encoded data based on the error correction code when an error in the encoded data is detected, acquiring the instruction from the corrected data, and executing the instruction.

2. The apparatus as claimed in claim 1 wherein the processing unit acquires the instruction from the encoded data after detecting the encoded data is correct, and then executes the instruction.

3. The apparatus as claimed in claim 1 wherein the encoded data is corrected by an error correction method, and the instruction is acquired from the corrected data by a decoding method.

4. The apparatus as claimed in claim 3 wherein the processing unit further stores the corrected data to the non-volatile memory device.

5. The apparatus as claimed in claim 4 wherein the instruction is acquired from the encoded data by a decoding method after detecting the encoded data is correct.

6. The apparatus as claimed in claim 5 further comprising a chip/chipset comprising the decoding method and the error correction method.

7. The apparatus as claimed in claim 1 wherein the encoded data and the corrected data correspond to Cross-Interleaved Reed-Solomon Code (CIRC), cyclic redundancy check code (CRCC), converlotion code, hamming code, Trelix code, Data Encryption Standard (DES) code.

8. The apparatus as claimed in claim 1 wherein the instruction comprises firmware of the apparatus.

9. A method for firmware management, executed by a processing unit of an apparatus comprising a non-volatile memory device, comprising:
acquiring encoded data comprising an instruction and an error correction code from the non-volatile memory device;
correcting the encoded data based on the error correction code when an error in the encoded data is detected;
acquiring the instruction from the corrected data; and
executing the instruction.

10. The method as claimed in claim 9 further comprising:
acquiring the instruction from the encoded data after detecting the encoded data is correct; and
executing the instruction.

11. The method as claimed in claim 9 wherein the encoded data and the corrected data correspond to Cross-Interleaved Reed-Solomon Code (CIRC), cyclic redundancy check code (CRCC), converlotion code, hamming code, Trelix code, Data Encryption Standard (DES) code.

12. The method as claimed in claim 9 wherein the instruction comprises firmware of the apparatus.

13. The method as claimed in claim 9 wherein the encoded data is corrected by an error correction method, and the instruction is acquired from the corrected data by a decoding method.

14. The method as claimed in claim 13 wherein the decoding method and the error correction method are implemented as a chip/chipset in the apparatus.

15. The method as claimed in claim 14 further comprising storing the corrected data to the non-volatile memory device.

16. The method as claimed in claim 15 further comprising:
acquiring the instruction from the encoded data after detecting the encoded data is correct; and
executing the instruction.

17. The method as claimed in claim 16 wherein the instruction comprises firmware of the apparatus.

18. A method for firmware management, executed by a processing unit of an apparatus comprising a non-volatile memory device, comprising:
acquiring an instruction corresponding to firmware of the apparatus;
inserting an error correction code into the instruction to generate encoded data by an encoding method, the error correction code is employed to validate the instruction; and
storing the encoded data to the non-volatile memory device.

19. The method as claimed in claim 18 wherein the instruction is downloaded from a website.

20. The method as claimed in claim 19 wherein the encoded data and the corrected data correspond to Cross-Interleaved Reed-Solomon Code (CIRC), cyclic redundancy check code (CRCC), converlotion code, hamming code, Trelix code, Data Encryption Standard (DES) code.
